(19) United States
(12) Patent Application Publication
(10) Pub. No.: US 2026/0255425 A1
(43) Pub. Date: Aug. 27, 2026

(54) DATA TRANSMISSION ON A MULTI-SUBSCRIBER IDENTITY MODULE DEVICE BASED ON DATA PATH LINK METRICS

(71) Applicant: QUALCOMM Incorporated, San Diego, CA (US)

(72) Inventors: Ling XIE, Beijing (CN); Qingxin CHEN, San Diego, CA (US); Liang HONG, Beijing (CN); Kiran PATIL, San Diego, CA (US); Rishav REJ, Pleasanton, CA (US); Tom CHIN, San Diego, CA (US); Can ZHAO, San Diego, CA (US); Daowei LIN, Shenzhen (CN); Yi DONG, Beijing (CN); Ning ZHAO, Beijing (CN); Mutaz Zuhier Afif SHUKAIR, San Diego, CA (US); Jiming GUO, Beijing (CN); Xiaoyu LI, Beijing (CN); Uttam PATTANAYAK, San Diego, CA (US); Liping SHEN, San Diego, CA (US); Subashini KRISHNAMURTHY, San Diego, CA (US); Lan LAN, San Diego, CA (US)

(21) Appl. No.: 18/875,862

(22) PCT Filed: Aug. 30, 2022
(86) PCT No.: PCT/CN2022/115710

§ 371 Date: Dec. 17, 2024

(51) Int. Cl. H04W 76/20; H04B 17/309; H04B 17/318

(52) U.S. Cl. CPC H04W 76/20; H04B 17/328; H04B 17/346

(57) ABSTRACT

Certain aspects of the present disclosure provide techniques for communications at a user equipment (UE). In one example embodiment a method includes collecting data path link metrics for multiple links associated with at least a first subscriber identity module (SIM) and a second SIM at a first logical layer of the UE; providing information regarding the collected data path link metrics to a second logical layer of the UE; and selecting, at the second logical layer, a data transmission mode based on the information regarding the collected data path link metrics.

### BACKGROUND

### Field of the Disclosure

Aspects of the present disclosure relate to wireless communications, and more particularly, to techniques for data transmission on multi-subscriber identity module (MSIM) devices based on data path link metrics.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes collecting data path link metrics for multiple links associated with at least a first subscriber identity module (SIM) and a second SIM at a first logical layer of the UE; providing information regarding the collected data path link metrics to a second logical layer of the UE; and selecting, at the second logical layer, a data transmission mode based on the information regarding the collected data path link metrics.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example multi-SIM deployment for a UE, in accordance with certain aspects of the present disclosure.

FIG. 6 depicts a timing diagram showing different subscribers (SUBs) in different states.

FIG. 7 depicts an example of data paths for a DSDA device.

FIGS. 8A and 8B depict diagrams showing different data path metrics for different SUBs.

FIG. 9 depicts a timing diagram comparing metrics on different data paths for different SUBs.

FIG. 10 depicts a chart showing data transmission modes for an MSIM device.

FIG. 11 depicts example data path metrics that may be monitored for an MSIM device, in accordance with aspects of the present disclosure.

FIG. 12 depicts a flow diagram showing data transmission mode selection based on data path metrics, in accordance with aspects of the present disclosure.

FIG. 13 depicts a graph showing possible games performing data transmission mode selection based on data path metrics, in accordance with aspects of the present disclosure.

FIG. 14 depicts a method for wireless communications.

FIG. 15 depicts aspects of an example communications device.

### DETAILED DESCRIPTION

Aspects of the present disclosure provide apparatuses, methods, processing systems, and computer-readable mediums for techniques for data transmission on multi-subscriber identity module (MSIM) devices based on data path link metrics.

Concurrent radio-access technology (RAT) operation generally refers to operating multiple simultaneous active connections. Multi-SIM devices are able to connect to multiple networks independently without network awareness. Different UE behaviors may occur based on different implementations like dual-SIM dual active (DSDA) or dual-SIM dual standby (DSDS). DSDS generally refers to a dual-SIM deployment where the two SIM cards of the UE may be unable to simultaneously generate traffic.

DSDA on the other hand refers to a dual-SIM deployment where both SIM cards of the UE may be active at the same time. The two SIMs may use independent radio frequency (RF) resource or share RF resources and both may suffer RF limitations on transmission (Tx) and reception (Rx) capability during DSDA. The SIMs may be connected to different networks or different base stations of the same network. As such, when operation in DSDA mode, there may be two possible data paths available for upper layer traffic (e.g., traffic to/from an application layer).

Different services have different transmission requirements (e.g., in terms of packet delay, packet error rate and data rate). Conventional channel condition metrics that indicate general channel conditions, may not be able to directly reflect the data transmission performance. The data transmission performance more dynamically relies on instant network configuration, scheduling rate, bandwidth, dedicated channel quality, and the like.

On a DSDA device, there are two independent stacks and data paths available. This provides an opportunity for flexible data transmission, for example, by dynamically selecting a better data transmission path based on instant conditions (e.g., type of RAT, frequency, configurations, and the like).

One challenge in DSDA scenarios, is how to pick an optimal data path or data paths for a particular service. Aspects of the present disclosure, however, provide mechanisms for monitoring metrics, or key performance indicators (KPI), for different data paths. Transmissions modes involving one or more multiple data paths may be selected, based on the monitored data path metrics. By considering path link metrics for the different data paths, when selecting a data transmission mode, data throughput may be significantly improved.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

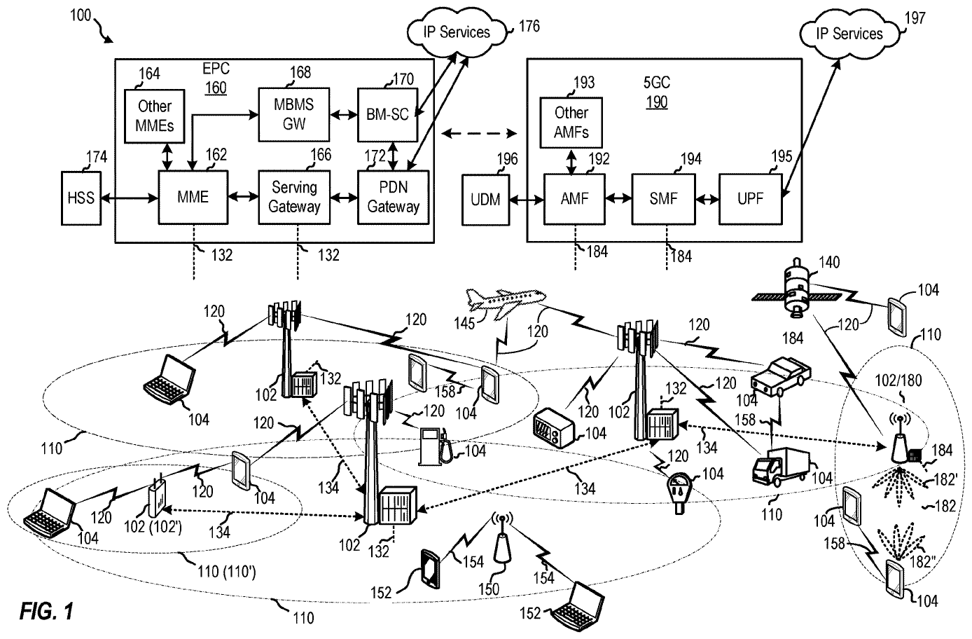

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

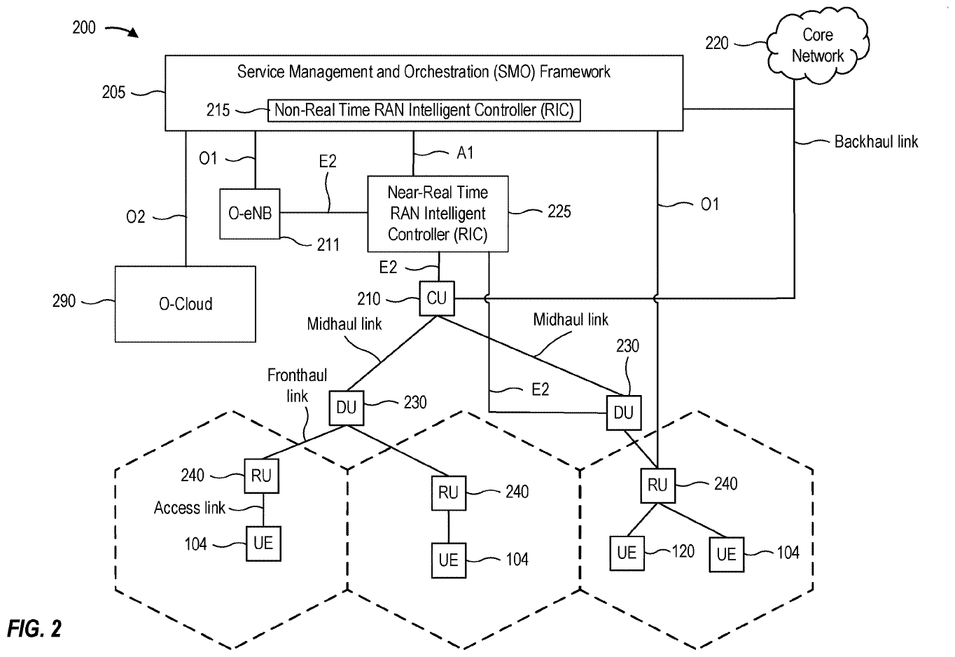

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

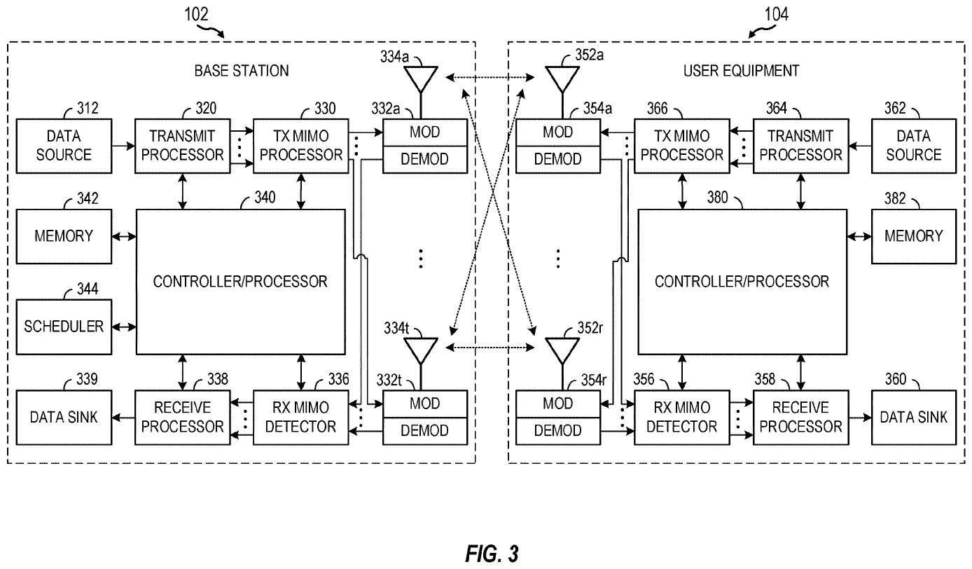

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

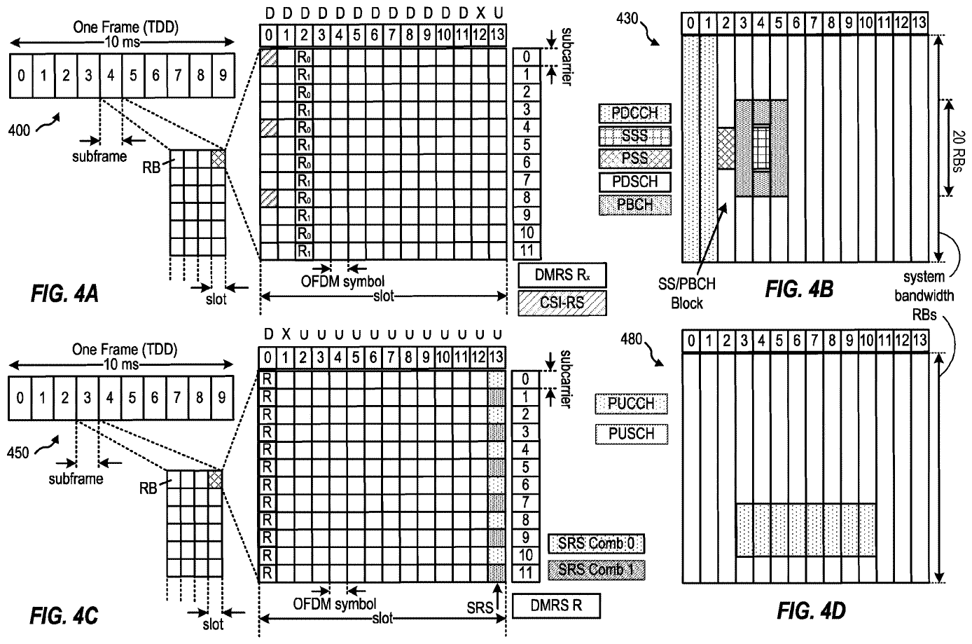

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of MSIM Operation

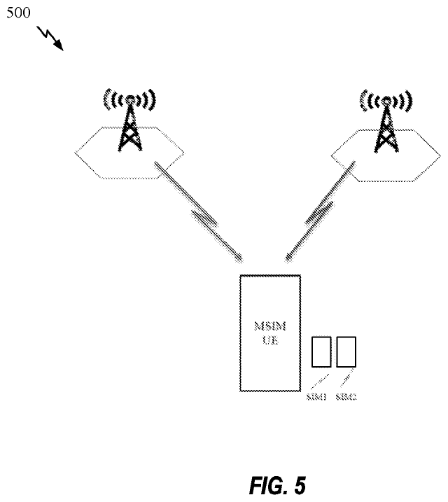

FIG. 5 depicts an example multi-SIM (MSIM) deployment, in which a UE supports multiple SIMs (SIM1 and SIM2), which may support the same or different radio access technologies (RATs). At any given time, the multiple SIMs may concurrently be in an idle state and may support different modes of operation. For example, a UE with a single receiver may support a Single Receive Dual SIM Dual Standby (SR-DSDS) mode, where only one RAT is received at a time. In a Dual Receive (DR)-DSDS mode, the MSIM UE may simultaneously multiple RATs at a time.

NR concurrent radio-access technology (RAT) operation generally refers to operating multiple simultaneous active connections with at least one connection being on NR. For example, the two connections may involve LTE and NR connections, or both NR connections. Multi-SIM devices are able to connect to multiple networks independently without network awareness. Different UE behaviors may occur based on different implementations like dual-SIM dual active (DSDA) or dual-SIM dual standby (DSDS). DSDS generally refers to a dual-SIM deployment where the two SIM cards of the UE may be unable to simultaneously generate traffic. DSDA on the other hand refers to a dual-SIM deployment where both SIM cards of the UE may be active at the same time. As used herein, a SIM generally refers to both virtual and hardware implementations of a SIM. In other words, each SIM may be implemented using hardware (e.g., a physical SIM card) on the multi-SIM device, or implemented virtually using a remote database.

Dual SIM receivers allow the different SIMs to support a variety of different combination options. For example, dual-SIM (DSIM) devices could support the following:
SA-NR+SA-NR: both SIMs could support standalone (SA) NR (SA-NR);
NSA-NR+LTE: one SIM supports non-standalone (NSA) while another SIM supports LTE;
LTE+LTE: both SIMs support LTE;
LTE+W: one SIM supports LTE, the other supports wideband CDMA; or any other combination (X RAT+X RAT both SIMs the same RAT or X RAT+Y RAT the SIMS support different RATs).

In some cases, in a multi-SIM deployment, each SIM of the UE can belong to the same network carrier. For example, two or more SIMs (also referred to herein as subscribers or SUBs) belonging to the same operator can be in the following modes:
(1) Idle+Idle: 2 or more SUBs in Idle camp to the same cell
(2) Connected+Idle: 1 SUB in Idle and 1 Sub Connected camp to the same cell.

### Aspects Related to Data Transmission on a Multi-Subscriber Identity Module Device Based on Data Path Link Metrics

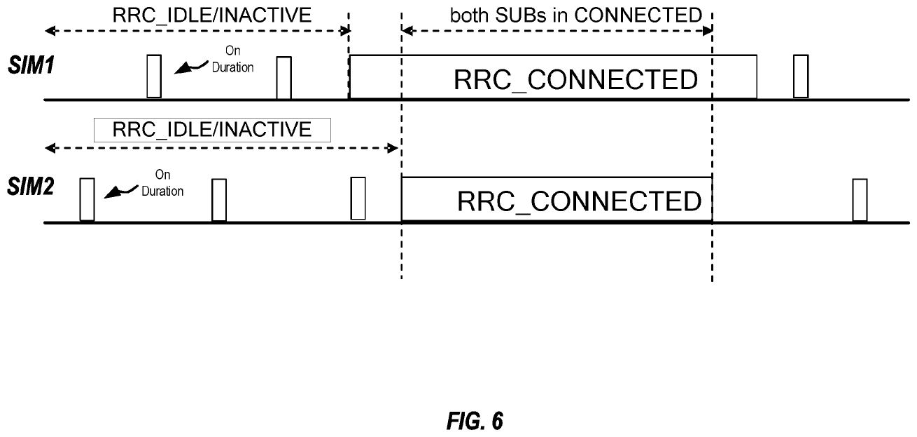

As illustrated in FIG. 6, in DSDA mode, two SIMs (SIM1 and SIM2) may be concurrently in a connected state with Tx active. As illustrated, the duration and periodicity of the RRC Connected state for each SIM may differ. And in between connected states, when the SIMs are in radio resource control (RRC) idle or inactive states, each SIM may wake up during On durations to monitor for paging.

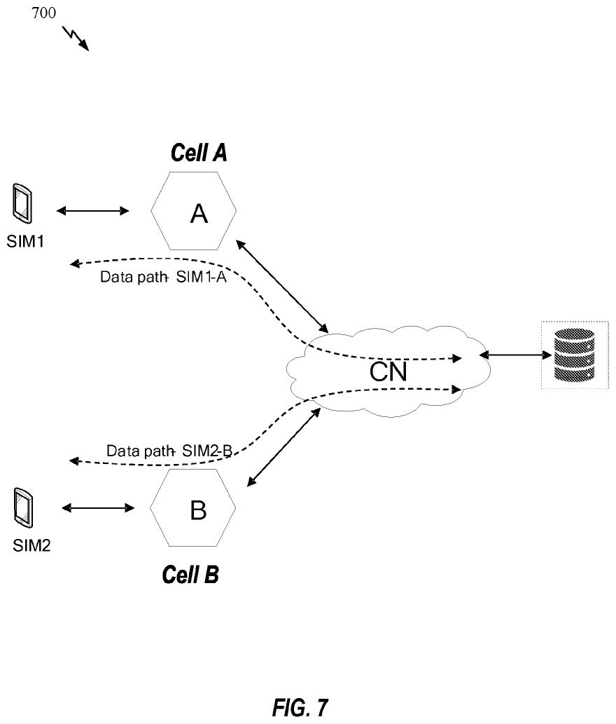

The two SIMs may use independent RF resources or share RF resources and both may suffer RF limitations on Tx and Rx capability during DSDA. As illustrated in FIG. 7, the SIMs may be connected to different networks or different base stations of the same network. As such, when operation in DSDA mode, there may be two possible data paths available for upper layer traffic. In the example illustrated in FIG. 7, SIM1 is connected to (a core network CN of) the network via Cell A, while SIM2 is connected via Cell B.

As noted above, one challenge in DSDA scenarios, is how to pick an optimal data path or data paths for a particular service. Conventional channel condition metrics, such as reference signal (RS) received power (RSRP), RS received quality (RSRQ), and signal to noise ratio (SNR) can indicate the general channel conditions but may not be able to directly reflect the data transmission performance. The actual data transmission performance more dynamically relies on metrics indicative of an instant network configuration, such as scheduling rate, bandwidth, and dedicated channel quality.

On a DSDA device, there are two independent stacks/data paths available. As a result, there may be more flexibility and potentially better data transmission can be provided by dynamically/statically selecting a better data transmission path based on current conditions (type of RAT, frequency, configurations, etc.). In some cases a UE may choose to aggregate two data paths to achieve larger transmission bandwidth.

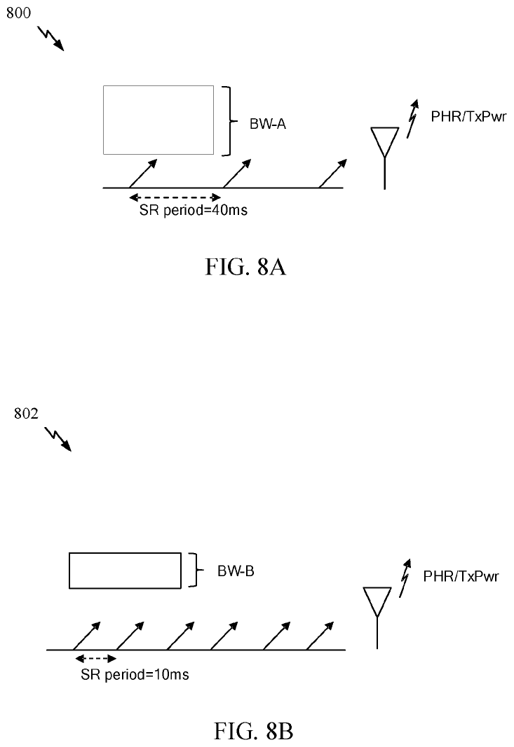

FIGS. 8A and 8B illustrate how different SIM data paths may have different metrics that could impact data throughput. In the illustrated example, Cell A (BW-A) has significantly more bandwidth than Cell B (BW-A). On the other hand, the scheduling request (SR) period is 40 ms for Cell A and only 10 ms for Cell B. The amount of Tx power headroom (PHR) on each data path may also be considered, when deciding which path(s) to select.

By considering such path link metrics for the different data paths, when selecting a data transmission mode, aspects of the present disclosure may help improve data throughput. As will be described in greater detail below, a UE may have a module configured to monitor and collect data path link metrics for multiple links associated with at least a first subscriber identity module (SIM) and a second SIM at a first logical layer of the UE (e.g., a physical/PHY layer). The module may provide information regarding the collected data path link metrics to a second logical layer of the UE (e.g., an application/APP layer), which may select a data transmission mode based on the information regarding the collected data path link metrics.

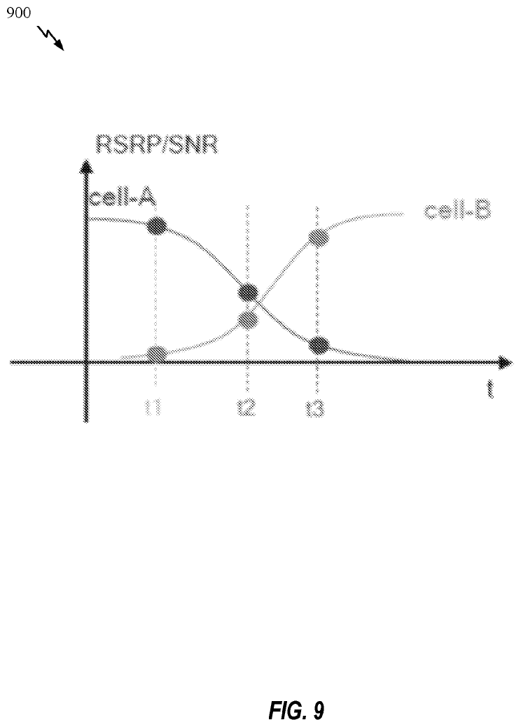

FIG. 9 illustrates how various metrics, such as the ratio of RSRP to SNR may vary over time. According to aspects of the present disclosure, short term (or instantaneous) values of various such data path (KPI) metrics may be considered to (dynamically or statically) select a data path. In some cases, KPI per traffic type may be considered, such as round trip time (RTT) delay or data throughput, to determine which path(s) to select (e.g., SIM1 through Cell A or SIM2 through Cell B or both).

Referring to FIG. 9, at a first time (@t1), SIM1 on Cell-A has a much better RSRP/SNR than cell-B and also better RTT. Therefore, in this case, the data path of SIM1-Cell A can be chosen.

At a second time (@t2), SIM1 on cell-A and SIM2 on cell-B have comparable RSRP/SNR. However, since the Cell-B SR period is much shorter than the Cell-A SR period, data path SIM2-Cell B can be chosen for the latency sensitive traffic. Cell-A BW is much wider than Cell-B BW, therefore both data paths may be chosen for throughput heavy traffic.

At a third time (@t3), SIM2 on Cell-B has a much better RSRP/SNR ratio than cell-A and also better RTT. Therefore, in this case, the data path for SIM2-Cell B can be chosen.

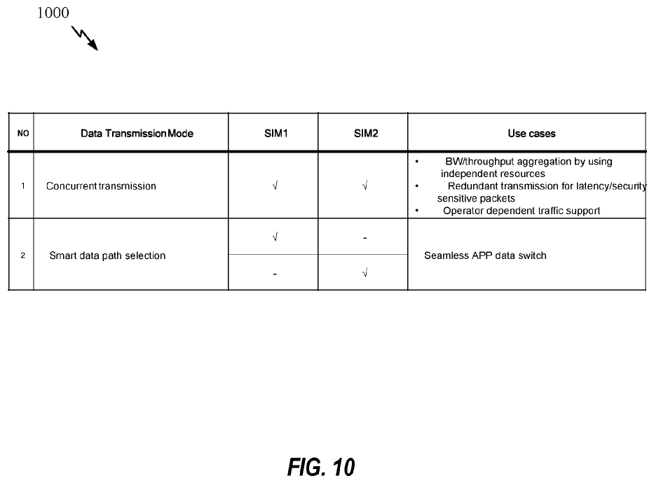

FIG. 10 summarizes the different DSDA device data transmission modes that may be selected. A first mode (No. 1) may correspond to concurrent transmission through both SIM1 and SIM2. This mode may be used, for example, for traffic that could benefit from increased BW and throughput aggregation by using independent resources. This mode may also be selected to provide redundant transmission for latency and/or security sensitive packets or for operator dependent traffic support. A second mode (No. 2) may correspond to smart selection of one of the data paths, which may provide for seamless application (APP) data switching. In general, on each SUB, the selection of the most proper cell (RAT, freq, BWP) to perform transmission may be based on traffic type (e.g., delay sensitive or light/heavy data volume), as well as whether the two SUBs share hardware (HW) resources sharing mode.

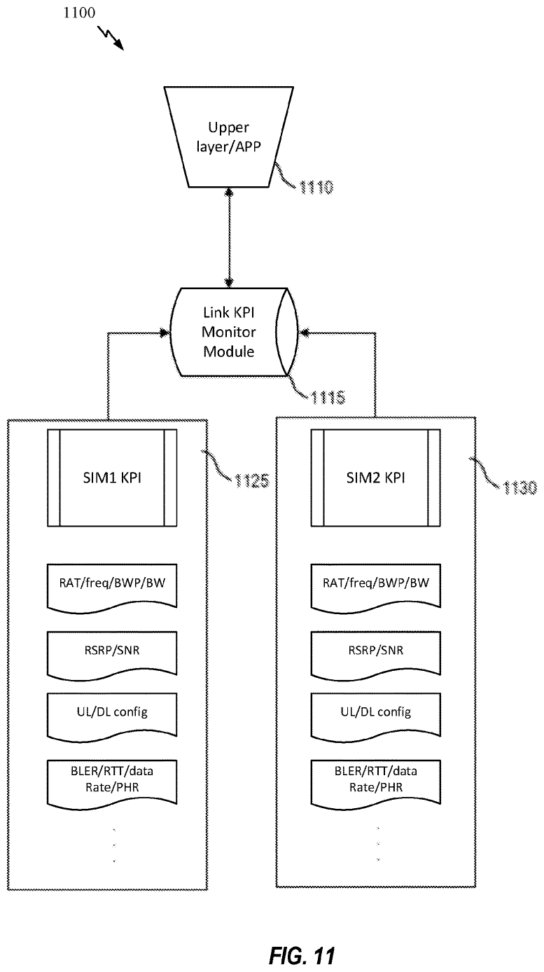

As illustrated in the flow diagram 1100 of FIG. 11, according to certain aspects of the present disclosure, a link KPI monitor module 1115 may be defined to collect data path link metrics for each SIM (SIM1 KPI 1125 and SIM2 KPI 1130). As illustrated, the KPI may include cell specific metrics, such as RSRP, SNR, RAT (e.g., RAT type or capability), and frequency. The KPI may also include instant traffic KPI metrics, such as average RTT, block error rate (BLER), scheduling rate, and data rate. In some cases, periodic link KPI collection of traffic KIP metrics may be triggered, for example, by a triggering connection to a specific server. As illustrated, the link KPI monitor module may provide information regarding monitored link KPI to an upper layer (e.g., an application/APP layer).

The link KPI monitor may provide current HW sharing status and may also link KPIs to the upper layer. In case SIM1 and SIM2 are in deep resource sharing (e.g., with a shared power amplifier (PA) which only allows one SUB to transmit at a time, the upper layer may suggest a modem to have one SUB change (e.g., RAT/Band) to use independent resources, as much as possible and trigger link KPI updates accordingly.

In some cases, an upper layer (e.g., APP layer) can decide the data transmission mode should be concurrent data transmission or a (single) selected data path transmission based on a link KPI module update.

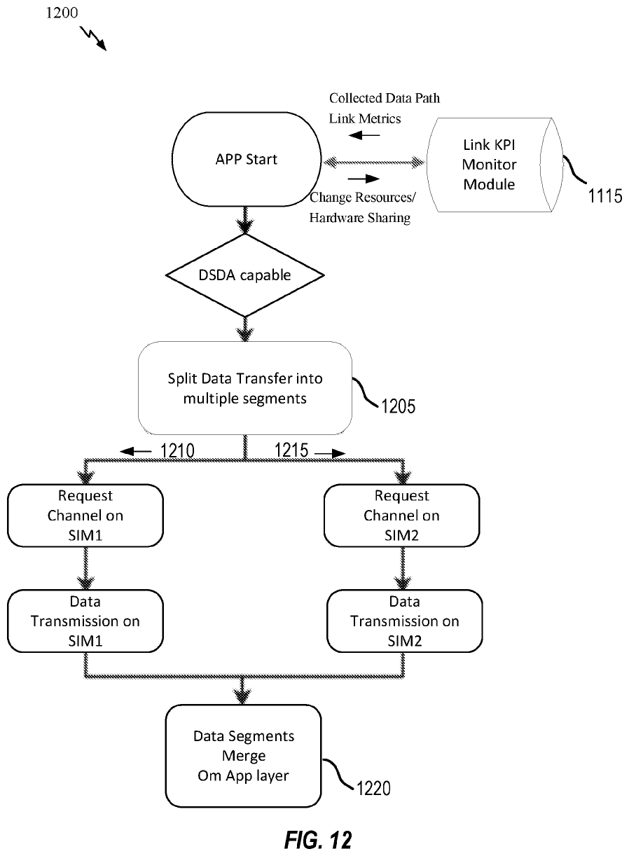

The flow diagram 1200 of FIG. 12 shows how the link KPI monitor module 1115 may provide updates regarding link KPIs to the APP layer. The APP layer may then decide on one of the DSDA data transmission modes (e.g., listed in the table of FIG. 10).

As illustrated in FIG. 12, at 1205, the APP layer may segment (split) large piece of data into multiple segments, then create/assign different streams (sockets) to transfer different segments. Based on the KPI updates, different streams with independent data packets or redundant data packets may be bound to SIM1 and SIM2 respectively, as shown in paths 1210 and 1215. As shown, at 1220, the APP layer may merge data from different streams over DSDA channels.

As illustrated in FIG. 12, the link KPI monitor module 1115 may provide the application layer information regarding collected data path link metrics. The APP layer may also signal the PHY layer. For example, the APP layer may signal the PHY layer (link KPI monitor module 1115) to change a RAT or frequency resources of at least one the first SIM or the second SIM (to use independent hardware resources) and/or to modify the hardware sharing status of the first and second SIMs.

By monitoring KPI on different data paths, aspects of the present disclosure may be able to better accommodate different traffic and different services that have different requirements. Some traffic may be defined by traffic delay, packet error rate or data rate, throughput sensitive traffic, latency sensitive traffic and different channel conditions may impact the data transmission. Monitoring data path KPIs may help select an optimal data path or data paths for transmission. Monitoring data path KPIs may provide a better indication of which path (or paths) is better for transmission than conventional (legacy) channel condition metrics.

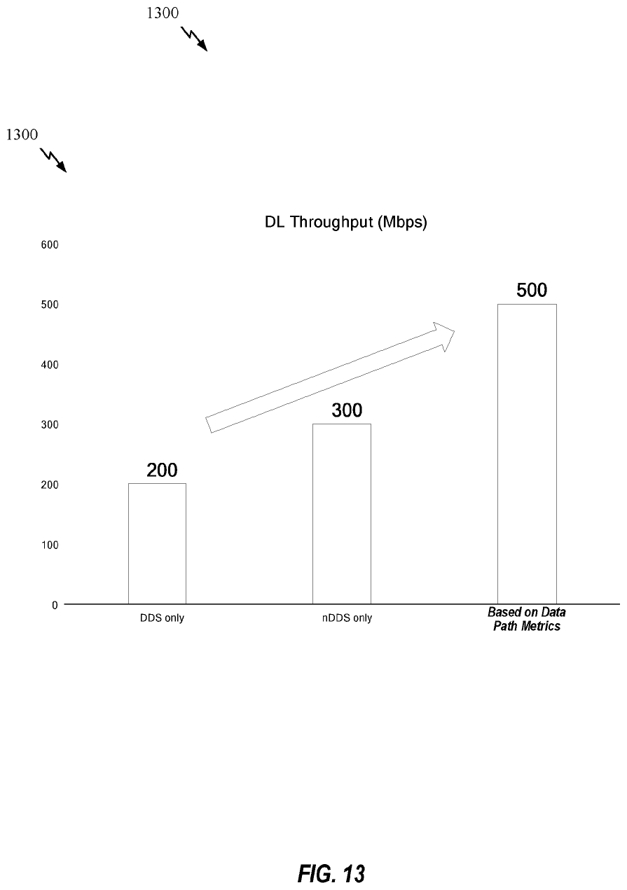

The chart 1300 of FIG. 13 illustrates an example of the possible improvements in data throughput that may be achieved by selecting a data transmission mode, based on data path metrics, in accordance with aspects of the present disclosure. As illustrated, assuming a dedicate data sub (DDS) has a downlink (DL) throughput of 200 Mbps and a non-dedicated data sub (nDDS) has a DL throughput of 300 Mbps, a download split over DDS and nDDS, based on data path metrics, may represent a significant gain (e.g., 150% gain compared to DDS only or a 70% gain compared to nDDS only).

### Example Operations of a User Equipment

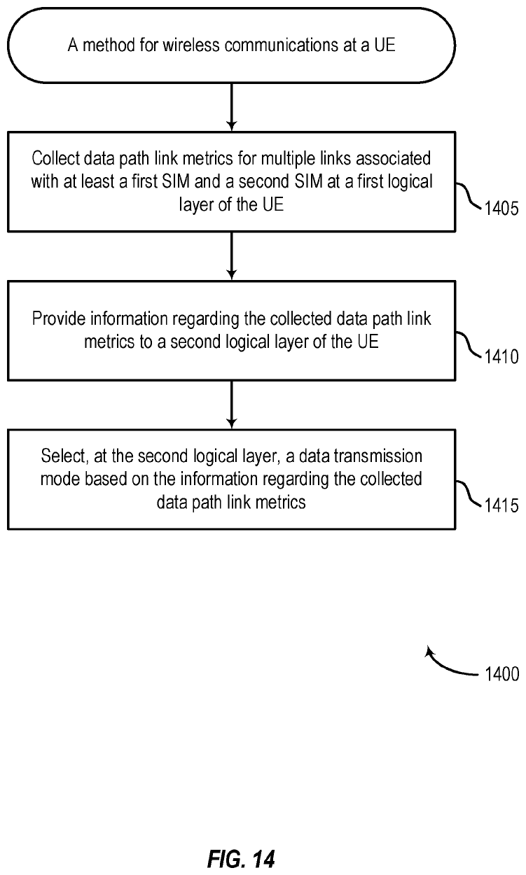

FIG. 14 shows an example of a method 1400 for wireless communications at a UE, such as a UE 104 of FIGS. 1 and 3.

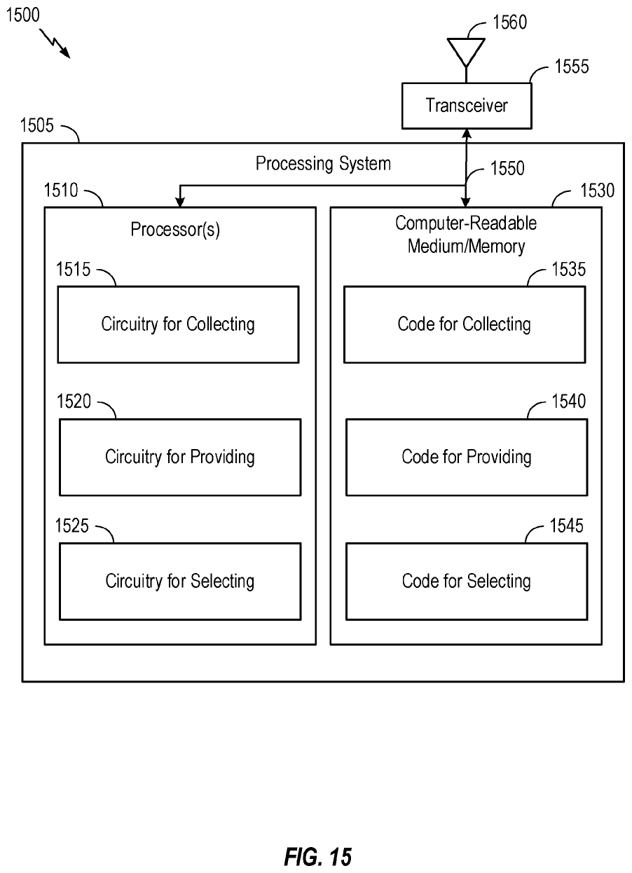

Method 1400 begins at step 1405 with collecting data path link metrics for multiple links associated with at least a first SIM and a second SIM at a first logical layer of the UE. In some cases, the operations of this step refer to, or may be performed by, circuitry for collecting and/or code for collecting as described with reference to FIG. 15.

Method 1400 then proceeds to step 1410 with providing information regarding the collected data path link metrics to a second logical layer of the UE. In some cases, the operations of this step refer to, or may be performed by, circuitry for providing and/or code for providing as described with reference to FIG. 15.

Method 1400 then proceeds to step 1415 with selecting, at the second logical layer, a data transmission mode based on the information regarding the collected data path link metrics. In some cases, the operations of this step refer to, or may be performed by, circuitry for selecting and/or code for selecting as described with reference to FIG. 15.

In some aspects, selecting the data transmission mode comprises selecting one of: a single path mode involving a link associated with the first SIM; a single path mode involving a link associated with the second SIM; or a concurrent path mode involving both the link associated with the first SIM and the link associated with the second SIM.

In some aspects, the data path link metrics comprise: cell specific data path link metrics; and traffic related data path link metrics.

In some aspects, the cell specific data path link metrics comprise at least one of: RSRP, SNR, a type of RAT, or available bandwidth.

In some aspects, the traffic related data path link metrics comprise at least one of RTT, BLER, scheduling rate, or data rate metrics.

In some aspects, selecting the data transmission mode is further based on UE battery power.

In some aspects, collecting data path link metrics is periodic and is triggered by at least one event.

In some aspects, the at least one event involves connection to a server.

In some aspects, the method 1400 further includes providing, to the second logical layer, information regarding a hardware sharing status of the first and second SIMs. In some cases, the operations of this step refer to, or may be performed by, circuitry for providing and/or code for providing as described with reference to FIG. 15.

In some aspects, the method 1400 further includes providing, by the second logical layer, signaling to the first logical layer to at least one of: change a RAT or frequency resources of at least one the first SIM or the second SIM to use independent hardware resources; or modify the hardware sharing status of the first and second SIMs. In some cases, the operations of this step refer to, or may be performed by, circuitry for providing and/or code for providing as described with reference to FIG. 15.

In some aspects, the method 1400 further includes providing, by the second logical layer, signaling to the first logical layer to update data path link metrics. In some cases, the operations of this step refer to, or may be performed by, circuitry for providing and/or code for providing as described with reference to FIG. 15.

In some aspects, data transmission modes are selected to segment data into multiple segments, wherein the multiple segments are transmitted as different streams.

In some aspects, different streams with independent data packets or redundant data packets are mapped to a first link associated the first SIM or a second link associated with the second SIM.

In some aspects, data transmission modes are selected to merge data from different streams over the multiple links associated with the first SIM and the second SIM.

In one aspect, method 1400, or any aspect related to it, may be performed by an apparatus, such as communications device 1500 of FIG. 15, which includes various components operable, configured, or adapted to perform the method 1400. Communications device 1500 is described below in further detail.

Note that FIG. 14 is just one example of a method, and other methods including fewer, additional, or alternative steps are possible consistent with this disclosure.

### Example Communications Device

FIG. 15 depicts aspects of an example communications device 1500. In some aspects, communications device 1500 is a user equipment, such as a UE 104 described above with respect to FIGS. 1 and 3.

The communications device 1500 includes a processing system 1505 coupled to the transceiver 1555 (e.g., a transmitter and/or a receiver). The transceiver 1555 is configured to transmit and receive signals for the communications device 1500 via the antenna 1560, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code) that when executed by the one or more processors 1510, cause the one or more processors 1510 to perform the method 1400 described with respect to FIG. 14, or any aspect related to it. Note that reference to a processor performing a function of communications device 1500 may include one or more processors 1510 performing that function of communications device 1500.

In the depicted example, computer-readable medium/memory 1530 stores code (e.g., executable instructions), such as code for collecting 1535, code for providing 1540, and code for selecting 1545. Processing of the code for collecting 1535, code for providing 1540, and code for selecting 1545 may cause the communications device 1500 to perform the method 1400 described with respect to FIG. 14, or any aspect related to it.

The one or more processors 1510 include circuitry configured to implement (e.g., execute) the code stored in the computer-readable medium/memory 1530, including circuitry such as circuitry for collecting 1515, circuitry for providing 1520, and circuitry for selecting 1525. Processing with circuitry for collecting 1515, circuitry for providing 1520, and circuitry for selecting 1525 may cause the communications device 1500 to perform the method 1400 described with respect to FIG. 14, or any aspect related to it.

Various components of the communications device 1500 may provide means for performing the method 1400 described with respect to FIG. 14, or any aspect related to it. For example, means for transmitting, sending or outputting for transmission may include transceivers 354 and/or antenna(s) 352 of the UE 104 illustrated in FIG. 3 and/or the transceiver 1555 and the antenna 1560 of the communications device 1500 in FIG. 15. Means for receiving or obtaining may include transceivers 354 and/or antenna(s) 352 of the UE 104 illustrated in FIG. 3 and/or the transceiver 1555 and the antenna 1560 of the communications device 1500 in FIG. 15.

### Example Clauses

Implementation examples are described in the following numbered clauses:
Clause 1: A method for wireless communications at a UE, comprising: collecting data path link metrics for multiple links associated with at least a first SIM and a second SIM at a first logical layer of the UE; providing information regarding the collected data path link metrics to a second logical layer of the UE; and selecting, at the second logical layer, a data transmission mode based on the information regarding the collected data path link metrics.
Clause 2: The method of Clause 1, wherein selecting the data transmission mode comprises selecting one of: a single path mode involving a link associated with the first SIM; a single path mode involving a link associated with the second SIM; or a concurrent path mode involving both the link associated with the first SIM and the link associated with the second SIM.
Clause 3: The method of any one of Clauses 1 and 2, wherein the data path link metrics comprise: cell specific data path link metrics; and traffic related data path link metrics.
Clause 4: The method of Clause 3, wherein the cell specific data path link metrics comprise at least one of: RSRP, SNR, a type of RAT, or available bandwidth.
Clause 5: The method of Clause 3, wherein the traffic related data path link metrics comprise at least one of RTT, BLER, scheduling rate, or data rate metrics.
Clause 6: The method of any one of Clauses 1-5, wherein selecting the data transmission mode is further based on UE battery power.
Clause 7: The method of any one of Clauses 1-6, wherein collecting data path link metrics is periodic and is triggered by at least one event.
Clause 8: The method of Clause 7, wherein the at least one event involves connection to a server.
Clause 9: The method of any one of Clauses 1-8, further comprising: providing, to the second logical layer, information regarding a hardware sharing status of the first and second SIMs.
Clause 10: The method of Clause 9, further comprising: providing, by the second logical layer, signaling to the first logical layer to at least one of: change a RAT or frequency resources of at least one the first SIM or the second SIM to use independent hardware resources; or modify the hardware sharing status of the first and second SIMs.
Clause 11: The method of Clause 10, further comprising: providing, by the second logical layer, signaling to the first logical layer to update data path link metrics.
Clause 12: The method of any one of Clauses 1-11, wherein data transmission modes are selected to segment data into multiple segments, wherein the multiple segments are transmitted as different streams.
Clause 13: The method of Clause 12, wherein different streams with independent data packets or redundant data packets are mapped to a first link associated the first SIM or a second link associated with the second SIM.
Clause 14: The method of any one of Clauses 1-13, wherein data transmission modes are selected to merge data from different streams over the multiple links associated with the first SIM and the second SIM.
Clause 15: An apparatus, comprising: a memory comprising executable instructions; and a processor configured to execute the executable instructions and cause the apparatus to perform a method in accordance with any one of Clauses 1-14.
Clause 16: An apparatus, comprising means for performing a method in accordance with any one of Clauses 1-14.
Clause 17: A non-transitory computer-readable medium comprising executable instructions that, when executed by a processor of an apparatus, cause the apparatus to perform a method in accordance with any one of Clauses 1-14.
Clause 18: A computer program product embodied on a computer-readable storage medium comprising code for performing a method in accordance with any one of Clauses 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications at a user equipment (UE), comprising:
collecting data path link metrics for multiple links associated with at least a first subscriber identity module (SIM) and a second SIM at a first logical layer of the UE;
providing information regarding the collected data path link metrics to a second logical layer of the UE; and
selecting, at the second logical layer, a data transmission mode based on the information regarding the collected data path link metrics.

2. The method of claim 1, wherein selecting the data transmission mode comprises selecting one of:
a single path mode involving a link associated with the first SIM;
a single path mode involving a link associated with the second SIM; or
a concurrent path mode involving both the link associated with the first SIM and the link associated with the second SIM.

3. The method of claim 1 wherein the data path link metrics comprise:
cell specific data path link metrics; and
traffic related data path link metrics.

4. The method of claim 3, wherein the cell specific data path link metrics comprise at least one of: Reference Signal Received Power (RSRP), Signal to Noise Ratio (SNR), a type of Radio Access Technology (RAT), or available bandwidth.

5. The method of claim 3, wherein the traffic related data path link metrics comprise at least one of Round Trip Time (RTT), Block Error Rate (BLER), scheduling rate, or data rate metrics.

6. The method of claim 1, wherein selecting the data transmission mode is further based on UE battery power.

7. The method of claim 1, wherein collecting data path link metrics is periodic and is triggered by at least one event.

8. The method of claim 7, wherein the at least one event involves connection to a server.

9. The method of claim 1, further comprising providing, to the second logical layer, information regarding a hardware sharing status of the first and second SIMs.

10. The method of claim 9, further comprising providing, by the second logical layer, signaling to the first logical layer to at least one of:
change a RAT or frequency resources of at least one the first SIM or the second SIM to use independent hardware resources; or
modify the hardware sharing status of the first and second SIMs.

11. The method of claim 10, further comprising providing, by the second logical layer, signaling to the first logical layer to update data path link metrics.

12. The method of claim 1, wherein data transmission modes are selected to segment data into multiple segments, wherein the multiple segments are transmitted as different streams.

13. The method of claim 12, wherein different streams with independent data packets or redundant data packets are mapped to a first link associated the first SIM or a second link associated with the second SIM.

14. The method of claim 1, wherein data transmission modes are selected to merge data from different streams over the multiple links associated with the first SIM and the second SIM.

15. An apparatus, comprising: at least one memory comprising instructions; and one or more processors configured to execute the instructions and cause the apparatus to:
collect data path link metrics for multiple links associated with at least a first subscriber identity module (SIM) and a second SIM at a first logical layer of a user equipment (UE);
provide information regarding the collected data path link metrics to a second logical layer of the UE; and
select, at the second logical layer, a data transmission mode based on the information regarding the collected data path link metrics.

16. The apparatus of claim 15, wherein selecting the data transmission mode comprises selecting one of:
a single path mode involving a link associated with the first SIM;
a single path mode involving a link associated with the second SIM; or
a concurrent path mode involving both the link associated with the first SIM and the link associated with the second SIM.

17. The apparatus of claim 15 wherein the data path link metrics comprise:
cell specific data path link metrics; and
traffic related data path link metrics.

18. The apparatus of claim 17, wherein the cell specific data path link metrics comprise at least one of: Reference Signal Received Power (RSRP), Signal to Noise Ratio (SNR), a type of Radio Access Technology (RAT), or available bandwidth.

19. The apparatus of claim 17, wherein the traffic related data path link metrics comprise at least one of Round Trip Time (RTT), Block Error Rate (BLER), scheduling rate, or data rate metrics.

20. The apparatus of claim 15, wherein selecting the data transmission mode is further based on UE battery power.

21. The apparatus of claim 15, wherein collecting data path link metrics is periodic and is triggered by at least one event.

22. The apparatus of claim 21, wherein the at least one event involves connection to a server.

23. The apparatus of claim 15, wherein the one or more processors are further configured to execute the instructions and cause the apparatus to provide, to the second logical layer, information regarding a hardware sharing status of the first and second SIMs.

24. The apparatus of claim 23, wherein the one or more processors are further configured to execute the instructions and cause the apparatus to provide, by the second logical layer, signaling to the first logical layer to at least one of:
change a RAT or frequency resources of at least one the first SIM or the second SIM to use independent hardware resources; or
modify the hardware sharing status of the first and second SIMs.

25. The apparatus of claim 24, wherein the one or more processors are further configured to execute the instructions and cause the apparatus to provide, by the second logical layer, signaling to the first logical layer to update data path link metrics.

26. The apparatus of claim 15, wherein data transmission modes are selected to segment data into multiple segments, wherein the multiple segments are transmitted as different streams.

27. The apparatus of claim 26, wherein different streams with independent data packets or redundant data packets are mapped to a first link associated the first SIM or a second link associated with the second SIM.

28. The apparatus of claim 15, wherein data transmission modes are selected to merge data from different streams over the multiple links associated with the first SIM and the second SIM.

29. An apparatus, comprising:
means for collecting data path link metrics for multiple links associated with at least a first subscriber identity module (SIM) and a second SIM at a first logical layer of the apparatus;
means for providing information regarding the collected data path link metrics to a second logical layer of the apparatus; and
means for selecting, at the second logical layer, a data transmission mode based on the information regarding the collected data path link metrics.

30. A non-transitory computer-readable medium comprising instructions that, when executed by one or more processors of an apparatus, cause the apparatus to:
collect data path link metrics for multiple links associated with at least a first subscriber identity module (SIM) and a second SIM at a first logical layer of the apparatus;
provide information regarding the collected data path link metrics to a second logical layer of the apparatus; and
select, at the second logical layer, a data transmission mode based on the information regarding the collected data path link metrics.
